(19) United States
(12) Patent Application Publication
(10) Pub. No.: US 2014/0175900 A1
(43) Pub. Date: Jun. 26, 2014

(54) HARD DISK DRIVE CONTROL CIRUIT

(71) Applicants: HON HAI PRECISION INDUSTRY CO., LTD., New Taipei (TW); HONG FU JIN PRECISION INDUSTRY (ShenZhen) CO.,LTD, Shenzhen (CN)

(72) Inventor: GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO.,LTD, Shenzhen (CN)

(21) Appl. No.: 14/101,402

(22) Filed: Dec. 10, 2013

(30) Foreign Application Priority Data
Dec. 26, 2012 (CN) 2012105728533

(51) Int. Cl. H01H 9/16

(52) U.S. Cl. CPC H01H 9/161
USPC 307/112

(57) ABSTRACT

A circuit for a hard disk drive (HDD) includes an indication unit, a HDD connector with a predefined pin, and a jumper coupled between the HDD connector and the indication unit. The jumper includes a base and a jumper block. The predefined pin performs different functions according to the jumper block being coupled between two corresponding pins of the base.

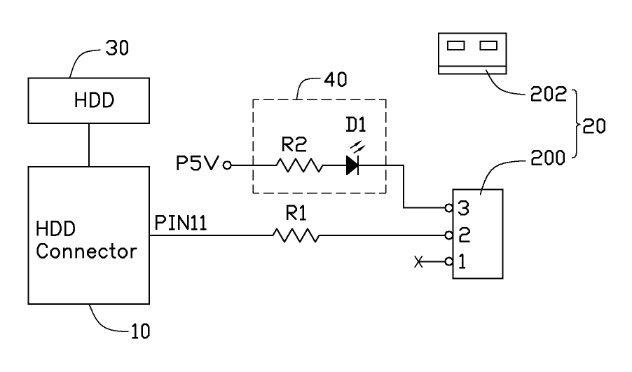

### BACKGROUND

1. Technical Field

The present disclosure relates to a hard disk drive (HDD) control circuit.

2. Description of Related Art

A predefined pin of a serial advanced technology attachment (SATA) connector of an HDD can perform two functions, one of which is outputting an indication signal to a light-emitting diode, and the other of which is performing over-current prevention. As to the former function, the predefined pin is coupled to the light-emitting diode to indicate states of the HDD. However, the predefined pin can only perform one function at a time, and it is inconvenient for a user to switch the pin to perform the other function.

Therefore, there is room for improvement in the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure. Moreover, in the drawing, like reference numerals designate corresponding parts throughout the several views.

The figure is a block diagram of an embodiment of a hard disk drive control circuit of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The figure illustrates an embodiment of a hard disk drive (HDD) control circuit of the present disclosure. The HDD control circuit comprises an HDD connector 10, a jumper 20, and an indication unit 40. The jumper 20 is coupled between the HDD connector 10 and the indication unit 40.

In one embodiment, the HDD connector 10 comprises a predefined pin PIN11. The predefined pin PIN11 can output an indication signal or be idle. The predefined pin PIN11 outputs the indication signal to indicate states, such as a normal state or an abnormal state, of an HDD 30 coupled to the HDD connector 10. When the predefined pin PIN11 is idle, the predefined pin PIN11 is capable of over-current prevention.

The jumper 20 comprises a base 200 and a jumper block 202. The base 200 comprises first to third pins 1-3. In one embodiment, the jumper block 202 can be manually switched to be coupled between the first pin 1 and the second pin 2, or be coupled between the second pin 2 and the third pin 3. When the jumper block 202 is coupled between the second pin 2 and the third pin 3, the first pin 1 is idle, the second pin 2 of the base 200 is coupled to the predefined pin PIN11 through a resistor R1, and the third pin 3 of the base 200 is coupled to the indication unit 40. The indication unit 40 comprises a light-emitting diode D1 and a resistor R2. An anode of the light-emitting diode D1 is coupled to a power terminal P5V through the resistor R2. A cathode of the light-emitting diode D1 is coupled to the third pin 3 of the base 200.

When the jumper block 202 is coupled between the second pin 2 and the third pin 3, the predefined pin PIN11 indicates the state of the HDD 30. Accordingly, when the predefined pin PIN11 outputs a low-level indication signal, such as logic 0, the light-emitting diode D1 emits light, thereby indicating the state of the HDD 30.

When the jumper block 202 is coupled between the first pin 1 and the second pin 2, the predefined pin PIN 11 performs over-current prevention.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A circuit for a hard disk drive (HDD), comprising:
an indication unit indicating states of the HDD;
a HDD connector connected to the HDD, and comprising a predefined pin; and
a jumper, comprising:
a base comprising first to third pins, wherein the first pin is idle, the second pin is coupled to the predefined pin of the HDD connector, and the third pin is coupled to the indication unit; and
a jumper block selectively connected between the first and second pins, or the second and third pins; wherein when the jumper block is connected between the first and second pins, the predefined pin is idle, when the jumper block is connected between the second and third pins, the predefined pin is coupled to the indication unit.

2. The circuit of claim 1, wherein the indication unit comprises a light-emitting diode, a cathode of the light-emitting diode is coupled to the third pin of the base, and an anode of the light-emitting diode is coupled to a power terminal

3. The circuit of claim 2, wherein the anode of the light-emitting diode is coupled to the power terminal through a resistor.

4. The circuit of claim 1, wherein the second pin of the base is coupled to the predefined pin through a resistor.
